(19) United States
(12) Patent Application Publication
(10) Pub. No.: US 2011/0080533 A1
(43) Pub. Date: Apr. 7, 2011

(54) Dithering Laser Drive Apparatus

(75) Inventors: Mark Champion, Kenmore, WA (US); Bruce C. Rothaar, Woodinville, WA (US)

(73) Assignee: MICROVISION, INC., Redmond, WA (US)

(21) Appl. No.: 12/574,317

(22) Filed: Oct. 6, 2009

(51) Int. Cl. H04N 5/74; H01S 3/10

(52) U.S. Cl. 348/744; 372/38.02; 348/E05.137

(57) ABSTRACT

A laser drive apparatus includes a plurality of transistors driven by different comparators. The different comparators receive an analog drive value and different ramp signals and produce pulse width modulated output signals. A calibration feedback circuit may be used to calibrate a power supply that provides a power supply voltage. A dither circuit may be used to reduce the number of bits received by the laser drive apparatus.

### FIELD

The present invention relates generally to driver circuits, and more specifically to driver circuits suitable to drive laser light sources.

### BACKGROUND

Direct modulation of laser diodes for video applications is typically performed using Class A amplifiers in which a series pass transistor varies the current supplied to the laser diode. Class A amplifiers are typically not very power efficient because much of the system power is dissipated by the series transistor. This inefficiency results in wasted power consumption which increases heat and reduces battery life.

### BRIEF DESCRIPTION OF THE DRAWINGS

FIG. 1 shows a pulse width modulating laser drive apparatus;

FIG. 2 shows waveforms in accordance with the operation of the apparatus of FIG. 1;

FIG. 3 shows a laser drive apparatus with a calibration circuit;

FIG. 4 shows a laser drive apparatus with a dither circuit;

FIG. 5 shows an example embodiment of a dither circuit;

FIG. 6 shows waveforms in accordance with operation of a dither circuit;

FIG. 7 shows a laser drive apparatus with a dither circuit;

FIG. 8 shows a color laser projection apparatus;

FIG. 9 shows a block diagram of a mobile device in accordance with various embodiments of the present invention;

FIG. 10 shows a mobile device in accordance with various embodiments of the present invention; and

FIG. 11 shows a flowchart in accordance with various embodiments of the present invention.

### DESCRIPTION OF EMBODIMENTS

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the invention, although different, are not necessarily mutually exclusive. For example, a particular feature, structure, or characteristic described herein in connection with one embodiment may be implemented within other embodiments without departing from the scope of the invention. In addition, it is to be understood that the location or arrangement of individual elements within each disclosed embodiment may be modified without departing from the spirit and scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

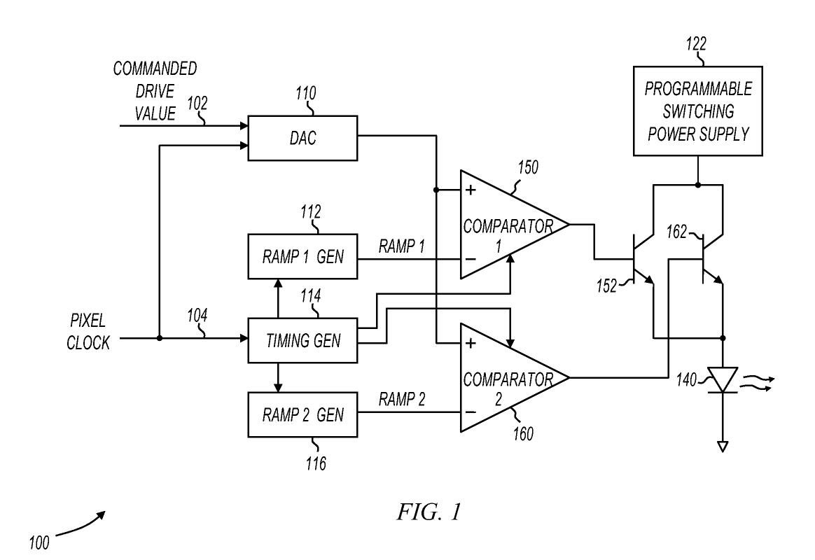

FIG. 1 shows a pulse width modulating laser drive apparatus. Apparatus 100 includes digital-to-analog converter (DAC) 110, ramp signal generators 112 and 116, timing generator 114, comparators 150 and 160, programmable switching power supply 122, transistors 152 and 162, and light source 140. In some embodiments, transistors 152 and 162 are switching transistors that are turned fully on or fully off. When on, the transistors have a very small voltage drop and dissipate very little power. This allows for very efficient operation.

In some embodiments, light source 140 is a laser light source. For example, in some embodiments light source 140 is a laser diode that produces red, green, or blue laser light. Light source 140 is not limited to laser embodiments. For example, other light sources, such as color filters or light emitting diodes (LEDs) or edge-emitting LEDs, could easily be substituted.

In operation, DAC 110 receives a commanded drive value on node 102 in the form of a digital word. DAC 110 also receives a pixel clock on node 104. At times specified by the pixel clock, DAC 110 converts the commanded drive value on node 102 to an analog laser drive value on node 111. Ramp generator circuits 112 and 116 generate voltage ramp signals that are provided to comparators 150 and 160. In response to the analog laser drive value and the ramp signals, comparators 150 and 160 produce pulse width modulated (PWM) output signals to drive transistors 152 and 162. By modulating the pulse width (time duration to turn on selected transistor), a variety of laser light output levels (referred to herein as “gray levels” or “grayscale”) can be produced using highly efficient switching transistors, thereby saving system power.

The commanded drive value represents a desired output luminance for a particular amount of time (e.g., one pixel). When the commanded drive value represents one pixel of a video display, the commanded value changes at the pixel rate as determined by the pixel clock. In some embodiments, the pixel clock has a fixed period. In other embodiments, the pixel clock has a variable period.

As shown in FIG. 1, in some embodiments, two comparators may be used to alleviate a practical problem with the ramp generators. For example, it may be impractical to slew the output of one ramp generator from its highest value at the end of the each pixel, to its lowest value at the beginning of the next pixel in essentially zero time. In embodiments with multiple comparators and multiple ramp generators, each ramp generator is allowed to slew down to zero during the subsequent pixel time, during which the other ramp generator is used to maintain the drive pulses to the laser. Timing generator circuit 114 provides timing signals necessary to alternately select comparators and ramp generators. For example, timing generator 114 may alternately disable each of the two comparators during their slew down pixel interval.

Programmable switching power supply 122 may be any type of switching power supply. For example, programmable switching power supply 122 may be a pulse width modulating (PWM) power supply switching at any frequency. Switching power supplies are generally known in the art, and the various embodiments of the present invention are not limited by the implementation details of programmable switching power supply 122.

Transistors 150 and 160 are shown as bipolar junction transistor (BJT), although this is not a limitation of the present invention. Any switching device suitable to provide current to a laser light source may be substituted therefor and is considered equivalent. For example, a field effect transistor (FET) such as a junction FET (JFET) or metal oxide semiconductor FET (MOSFET) may be utilized for transistors 150 and 160 without departing from the scope of the present invention.

Although FIG. 1 shows two comparators and two ramp generators, this is not a limitation of the present invention. For example, in some embodiments, more than two comparators and more than two ramp generators are employed and alternately enabled. Any number of comparators and any number of ramp generators may be utilized without departing from the scope of the present invention.

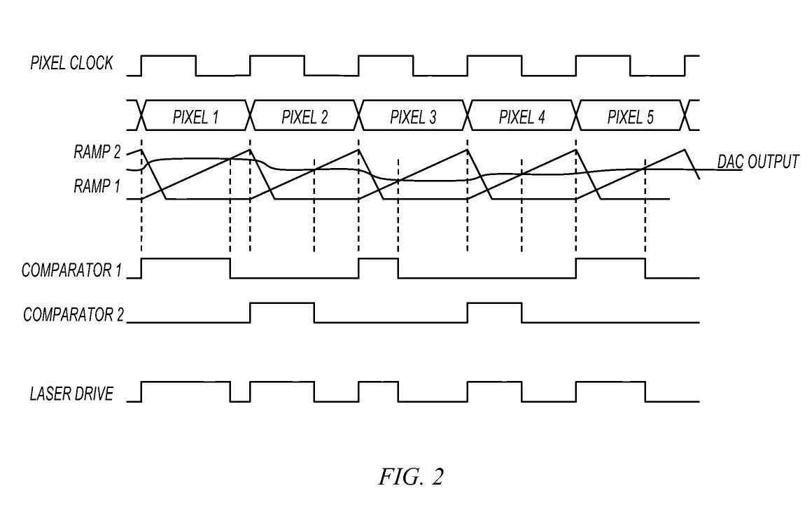

FIG. 2 shows waveforms in accordance with the operation of the apparatus of FIG. 1. Five pixel clock periods are shown in FIG. 2, corresponding to pixels one through 5. The two ramp signals (RAMP1, RAMP2) provide linear ramps for alternate pixels and do not need to be altered during operation. The ramps are engineered to start at zero at the beginning of the pixel, and produce their highest level at the end of the pixel. For example, RAMP1 ramps linearly for pixels 1, 3, and 5, whereas RAMP2 ramps linearly for pixels 2 and 4. In response to signals provided timing generator 114, comparators 1 and 2 are alternately enabled. For example, comparator 1 is enabled for pixels 1, 3, and 5, and comparator 2 is enabled for pixels 2 and 4.

In operation, the enabled comparator asserts its output at the beginning of the pixel and de-asserts its output when the corresponding ramp signal reaches the level of the output signal of DAC 110. Because transistors 150 and 160 are coupled in parallel, the comparator PWM output signals are combined to form a composite laser drive signal as shown in FIG. 2.

The effective resolution of this scheme depends on the accuracy of the ramp generators, and on the equivalent noise performance of the comparators. In some embodiments, some aspects of non-ideal behavior, such as non-linearity of the ramp waveforms, are calibrated out during calibration of the data path that provides the commanded drive value. The comparator output signal rise and fall times can be slow as long as the pulse width jitter is managed appropriately.

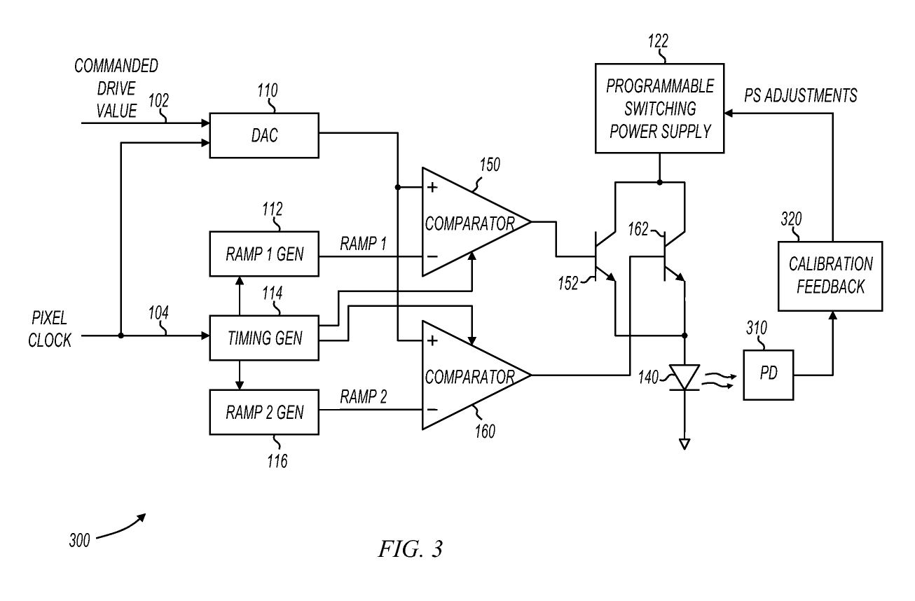

FIG. 3 shows a laser drive apparatus with a calibration circuit. Laser drive apparatus 300 includes all elements shown in FIG. 1. Laser drive apparatus 300 also includes photodetector 310 and calibration feedback circuit 320. In operation, photodetector 310 detects the amount of light produced by light source 140. Calibration feedback circuit 320 receives from photodetector 310 an indication of the amount of light produced, and provides power supply adjustment feedback to programmable switching power supply 122.

The power supply voltage value needed to produce specific currents (and light levels) may be learned by asserting values within the desired grayscale range, and slowly adjusting the power supply to maintain a suitable power supply voltage. In some embodiments, these calibration pulses are sent at times that the light source would otherwise be inactive. For example, in video applications, a calibration pulse may be sent at the top or bottom of the video frame. Calibration feedback circuit 320 may include any suitable loop filter for feedback. For example, calibration feedback circuit 320 may include a proportional-integral-derivative (PID) controller that is updated when the calibration pulses are issued.

Because the calibration feedback loop operates relatively slowly, in some embodiments, a microprocessor may be in the loop. For example, calibration feedback circuit 320 may include a processor or controller that executes instructions to adjust the power supplies in response to the measured light output.

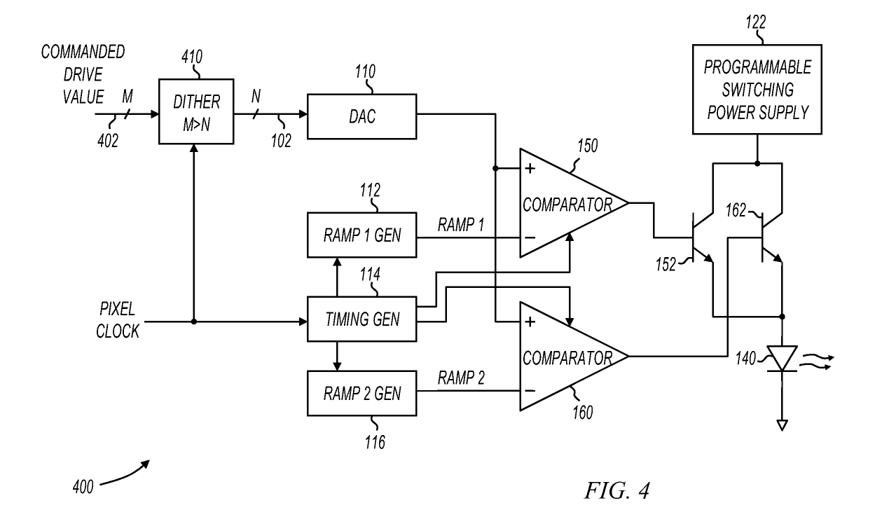

FIG. 4 shows a laser drive apparatus with a dither circuit. Laser drive apparatus 400 includes all elements shown in FIG. 1. Laser drive apparatus 400 also includes dither circuit 410. Dither circuit 410 receives the commanded drive value on node 402 and provides a digital word to DAC 110 on node 102.

The commanded drive value on node 402 is a digital word having M bits, and the digital word on node 102 has N bits, where M is greater than N. In operation, dither circuit 410 receives an M bit input word and produces an N bit output word by truncating the input. The truncated bits are added to the next input value and the process repeats. When each input value is truncated, a lesser value output (corresponding to a dimmer light output) results, but the truncated bits increase the value of a later output.

As an example, consider the case in which M=10 and N=4. The commanded drive value can range from zero to 1023, however there are only 16 possible output values: 0, 64, 128, 192, 256, 320, 384, 448, 512, 576, 640, 704, 768, 832, 896, and 960; corresponding to zero through 15 on the N-bit output. Input values from zero to 63 are truncated down to an output value of zero. Similarly, input values from 64 to 127 are truncated down to an output value of 64.

The difference between the input values and the truncated output values is referred to herein as the “residual.” The residual is added to the next input value. For example, if the input value is 522, the truncated output value is 512 and the residual of 10 is added to the next input value.

As another example, consider a consecutive string of input values of 48. The corresponding string of output values will be 0, 64, 64, 64, 0, 64, 64, 64, etc. The average output value is 48.

Because of the truncation, the output value cannot accommodate values over 960. In some embodiments, dither circuit 410 scales the input value down by 960/1023 so that the full range of input values is represented by the full range of possible output values. In other embodiments, dither circuit 410 includes limiting logic to limit the input value to the maximum truncated value, in this example, 960.

In some embodiments, dither circuit 410 employs a “look-ahead” feature that looks at future commanded drive values when producing the current output value. For example, a moving average filter may be employed prior to truncation. In other embodiments, a random number generator weighted by the residual is used to determine which of two adjacent output values will be generated. In still further embodiments, temporal dithering is employed. Any type of dithering may be used to reduce the M-bit commanded drive value to an N-bit drive value without departing from the scope of the present invention.

FIG. 5 shows an example embodiment of a dither circuit. Dither circuit 410 includes accumulator 510 and incrementer 520. As described above with reference to FIG. 4, dither circuit 410 receives an M-bit digital input word and produces an N-bit digital output word, where M is greater than N.

In the example dithering circuit of FIG. 5, the M-bit input value is truncated to N bits, and the truncated LSBs form the residual. The residual values are accumulated by accumulator 510. When accumulator 510 overflows, incrementer 520 adds one to the N-bit output value. M and N can take on any values. In some embodiments, dither circuit 410 includes a scaling circuit to scale the maximum input value to the maximum output value.

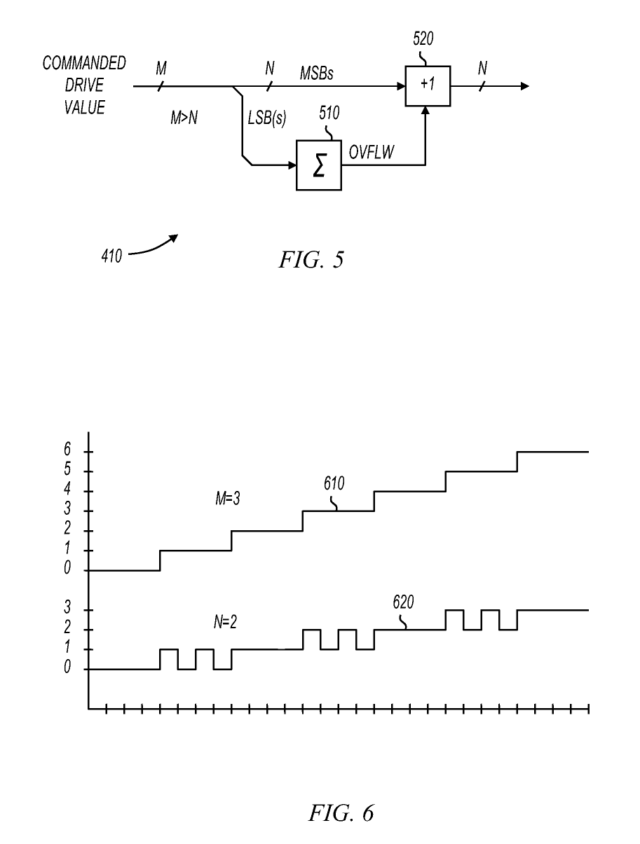

FIG. 6 shows waveforms in accordance with operation of a dither circuit. Waveforms 610 and 620 show operation of a dither circuit where M=3 and N=2. This is a simplified example to demonstrate dither circuit operation when only one bit is truncated. The input value can range from zero to seven, and the output value can range from zero to three. Waveform 610 is shown incrementing from zero to six.

Each tick on the horizontal axis represent one pixel time. When the input value is zero, the output value is also zero. When the input value is one, the output alternates between zero and one as the accumulator overflows. For this example where M=3 and N=2, odd input values cause the output to dither between two output values. In the simplified example of FIG. 6, the output cannot represent values corresponding to an input value of seven. In some embodiments, the output is limited to the values shown, and an input value of seven is limited to six. In other embodiments, the input value is scaled by 6/7 so that all possible input values can be represented by a two-bit output digital word.

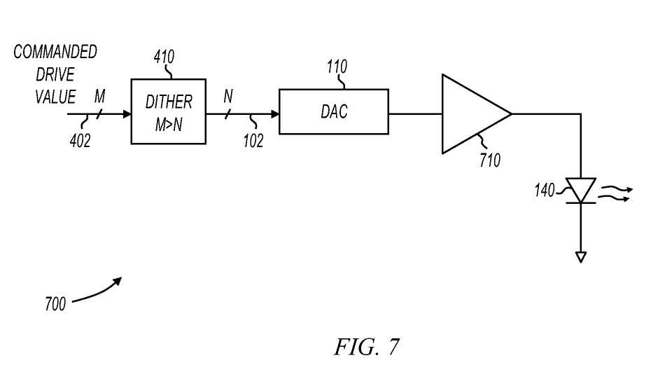

FIG. 7 shows a laser drive apparatus with a dither circuit. Laser drive apparatus 700 includes dither circuit 410, DAC 110, amplifier 710, and laser light source 140. Dither circuit 410, DAC 110 and laser light source 140 are described above with reference to previous figures. Amplifier 710 may be any type of amplifier. For example, in some embodiments, amplifier 710 includes parallel transistors, comparators, and ramp generators as shown in FIG. 1. In other embodiments, amplifier 710 includes a class A amplifier. Any type of amplifier may be utilized with a dither circuit to drive a laser light source as shown in FIG. 7 without departing from the scope of the present invention.

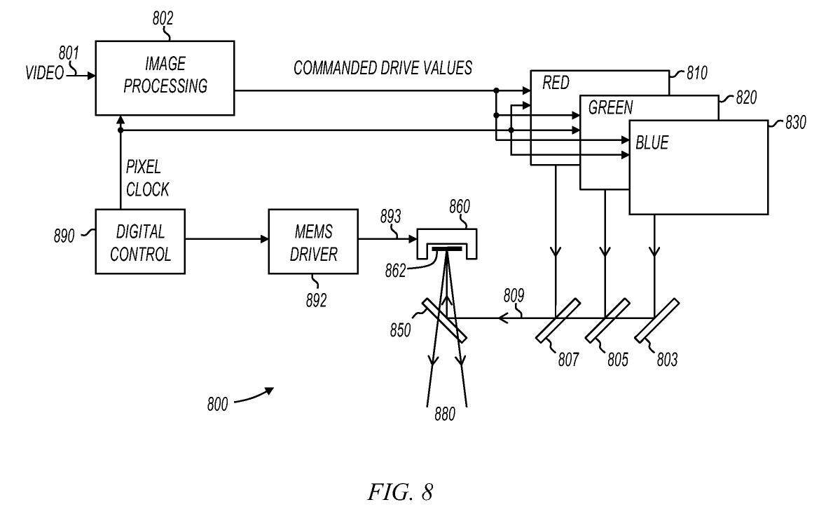

FIG. 8 shows a color laser projection apparatus. System 800 includes image processing component 802, laser light sources 810, 820, and 830. Projection system 800 also includes mirrors 803, 805, and 807, filter/polarizer 850, micro-electronic machine (MEMS) device 860 having mirror 862, MEMS driver 892, and digital control component 890.

In operation, image processing component 802 receives video data on node 801, receives a pixel clock from digital control component 890, and produces commanded drive values to drive the laser light sources when pixels are to be displayed. Image processing component 802 may include any suitable hardware and/or software useful to produce commanded drive values from video data. For example, image processing component 802 may include application specific integrated circuits (ASICs), one or more processors, or the like.

Laser light sources 810, 820, and 830 receive commanded drive values and produce light. Laser light sources 810, 820, and 830 may include any of the laser drive apparatus described herein. For example, laser light sources 810, 820, and 830 may include any of apparatus 100 (FIG. 1), 300 (FIG. 3), 400 (FIG. 4), or 700 (FIG. 7).

Each light source produces a narrow beam of light which is directed to the MEMS mirror via guiding optics. For example, blue laser light source 830 produces blue light which is reflected off mirror 803 and is passed through mirrors 805 and 807; green laser light source 820 produces green light which is reflected off mirror 805 and is passed through mirror 807; and red laser light source 810 produces red light which is reflected off mirror 807. At 809, the red, green, and blue light are combined. The combined laser light is reflected off mirror 850 on its way to MEMS mirror 862. The MEMS mirror rotates on two axes in response to electrical stimuli received on node 893 from MEMS driver 892. After reflecting off MEMS mirror 862, the laser light bypasses mirror 850 to create an image at 880.

The image at 880 may include image artifacts that result from dithering within laser light sources 810, 820, and 830. For example, a faint denim-like pattern may appear when residuals occur with some spatial frequency. These artifacts are most likely to be visible within homogeneous regions of static video. In some embodiments the patterns are kept from moving by clearing the residual value at the end of every frame. This ensures that consecutive static frames are rendered identically. In some embodiments, the pattern are allowed to move from frame to frame. For example, in some embodiments, the residual is retained at the end of every frame. In further embodiments, the residual is randomized at the end of every frame. These artifacts can also be reduced by reducing the dither magnitude (e.g., dither to eight bits rather than six bits).

The MEMS based projector is described as an example application, and the various embodiments of the invention are not so limited. For example, the laser drive apparatus described herein may be used with other optical systems without departing from the scope of the present invention.

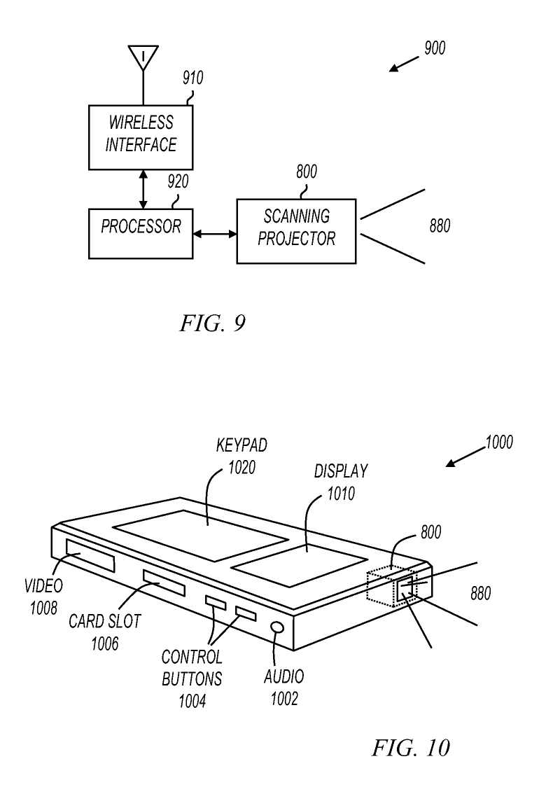

FIG. 9 shows a block diagram of a mobile device in accordance with various embodiments of the present invention. As shown in FIG. 9, mobile device 900 includes wireless interface 910, processor 920, and scanning projector 800. Scanning projector 800 paints a raster image at 880. Scanning projector 800 is described with reference to FIG. 8. In some embodiments, scanning projector 800 includes one or more laser drive apparatus with multiple drive transistors, comparators, and ramp generators, such as those shown in, and described with reference to, earlier figures.

Scanning projector 800 may receive image data from any image source. For example, in some embodiments, scanning projector 800 includes memory that holds still images. In other embodiments, scanning projector 800 includes memory that includes video images. In still further embodiments, scanning projector 800 displays imagery received from external sources such as connectors, wireless interface 910, or the like.

Wireless interface 910 may include any wireless transmission and/or reception capabilities. For example, in some embodiments, wireless interface 910 includes a network interface card (NIC) capable of communicating over a wireless network. Also for example, in some embodiments, wireless interface 910 may include cellular telephone capabilities. In still further embodiments, wireless interface 910 may include a global positioning system (GPS) receiver. One skilled in the art will understand that wireless interface 910 may include any type of wireless communications capability without departing from the scope of the present invention.

Processor 920 may be any type of processor capable of communicating with the various components in mobile device 900. For example, processor 920 may be an embedded processor available from application specific integrated circuit (ASIC) vendors, or may be a commercially available microprocessor. In some embodiments, processor 920 provides image or video data to scanning projector 800. The image or video data may be retrieved from wireless interface 910 or may be derived from data retrieved from wireless interface 910. For example, through processor 920, scanning projector 800 may display images or video received directly from wireless interface 910. Also for example, processor 920 may provide overlays to add to images and/or video received from wireless interface 910, or may alter stored imagery based on data received from wireless interface 910 (e.g., modifying a map display in GPS embodiments in which wireless interface 910 provides location coordinates).

FIG. 10 shows a mobile device in accordance with various embodiments of the present invention. Mobile device 1000 may be a hand held projection device with or without communications ability. For example, in some embodiments, mobile device 1000 may be a handheld projector with little or no other capabilities. Also for example, in some embodiments, mobile device 1000 may be a device usable for communications, including for example, a cellular phone, a smart phone, a personal digital assistant (PDA), a global positioning system (GPS) receiver, or the like. Further, mobile device 1000 may be connected to a larger network via a wireless (e.g., WiMax) or cellular connection, or this device can accept data messages or video content via an unregulated spectrum (e.g., WiFi) connection.

Mobile device 1000 includes scanning projector 800 to create an image with light at 880. Mobile device 1000 also includes many other types of circuitry; however, they are intentionally omitted from FIG. 10 for clarity.

Mobile device 1000 includes display 1010, keypad 1020, audio port 1002, control buttons 1004, card slot 1006, and audio/video (A/V) port 1008. None of these elements are essential. For example, mobile device 1000 may only include scanning projector 800 without any of display 1010, keypad 1020, audio port 1002, control buttons 1004, card slot 1006, or A/V port 1008. Some embodiments include a subset of these elements. For example, an accessory projector product may include scanning projector 800, control buttons 1004 and A/V port 1008.

Display 1010 may be any type of display. For example, in some embodiments, display 1010 includes a liquid crystal display (LCD) screen. Display 1010 may always display the same content projected at 880 or different content. For example, an accessory projector product may always display the same content, whereas a mobile phone embodiment may project one type of content at 880 while display different content on display 1010. Keypad 1020 may be a phone keypad or any other type of keypad.

A/V port 1008 accepts and/or transmits video and/or audio signals. For example, A/V port 1008 may be a digital port that accepts a cable suitable to carry digital audio and video data. Further, A/V port 1008 may include RCA jacks to accept composite inputs. Still further, A/V port 1008 may include a VGA connector to accept analog video signals. In some embodiments, mobile device 1000 may be tethered to an external signal source through A/V port 1008, and mobile device 1000 may project content accepted through A/V port 1008. In other embodiments, mobile device 1000 may be an originator of content, and A/V port 1008 is used to transmit content to a different device.

Audio port 1002 provides audio signals. For example, in some embodiments, mobile device 1000 is a media player that can store and play audio and video. In these embodiments, the video may be projected at 880 and the audio may be output at audio port 1002. In other embodiments, mobile device 1000 may be an accessory projector that receives audio and video at A/V port 1008. In these embodiments, mobile device 1000 may project the video content at 880, and output the audio content at audio port 1002.

Mobile device 1000 also includes card slot 1006. In some embodiments, a memory card inserted in card slot 1006 may provide a source for audio to be output at audio port 1002 and/or video data to be projected at 880. Card slot 1006 may receive any type of solid state memory device, including for example, Multimedia Memory Cards (MMCs), Memory Stick DUOS, secure digital (SD) memory cards, and Smart Media cards. The foregoing list is meant to be exemplary, and not exhaustive.

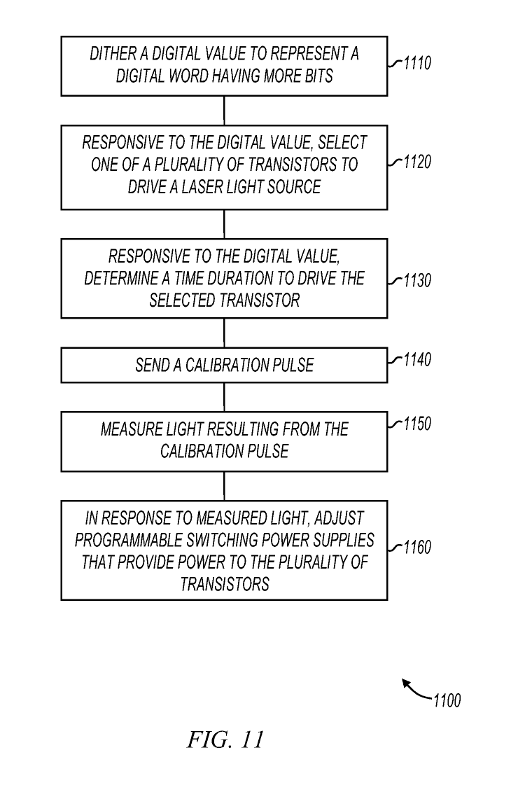

FIG. 11 shows a flowchart in accordance with various embodiments of the present invention. In some embodiments, method 1100, or portions thereof, is performed by a laser drive apparatus, a mobile projector, or the like, embodiments of which are shown in previous figures. In other embodiments, method 1100 is performed by an integrated circuit or an electronic system. Method 1100 is not limited by the particular type of apparatus performing the method. The various actions in method 1100 may be performed in the order presented, or may be performed in a different order. Further, in some embodiments, some actions listed in FIG. 11 are omitted from method 1100.

Method 1100 is shown beginning with block 1110 in which a digital value is dithered to represent a digital word having more bits. For example, a six bit output value may be dithered to represent a ten bit input value. Any of the dithering embodiments described above may be used to dither the digital value.

At 1120, a digital value is converted to an analog laser drive value. This corresponds to the operation of DAC 110 (FIGS. 1, 3, 4, and 7) converting a commanded drive value to an analog laser drive value.

At 1130, a plurality of ramp signals are generated. For example, in some embodiments, two ramp signals are generated as shown in FIG. 2. Each ramp signal may slew from zero to the maximum possible analog laser drive value for alternate pixels. In some embodiments, more than two ramp signals are generated. For example, three or four ramp signals may be generated, where each ramp signal signal slews from zero to the maximum for every three or four pixels.

At 1140, a plurality of comparators responsive to the analog laser drive signal and the plurality of ramp signals are alternately enabled. For example, referring now back to FIG. 2, comparators 150 and 160 are alternately enabled by timing generator circuit 114. The comparators compare the ramp signals with the analog laser drive signal to produce a pulse width modulated (PWM) signal. In some embodiments, more than two comparators are alternately enabled. For example, some embodiments include three comparators, and some embodiments include four comparators. The various embodiments of the invention are not limited by the number of comparators alternately enabled.

At 1150, a laser light source is driven by a plurality of transistors responsive to the plurality of comparators. When the plurality of comparators are alternately enabled, then the plurality of transistors alternately drive the laser light source. This is shown for two comparators in FIG. 2. The laser light source may be any type of laser light source without departing from the scope of the present invention.

At 1160, a calibration pulse is sent. In some embodiments, calibration pulses are sent during inactive video periods in a scanning laser projector. For example, calibration pulses may be sent at the end of video frames. Calibration pulses may always have the same drive values, or may have varying drive values.

At 1170, light resulting from the calibration pulse is measured. Referring back to FIG. 3, photodetector 310 measures the amount of light produced by a calibration pulse. At 1180, a programmable switching power supply that provides power to the plurality of transistors is adjusted in response to the measured light. This corresponds to calibration feedback circuit 320 adjusting power supply 122. At 1190, a mirror that reflects the laser light is scanned to generate a raster image. For example, mirror 862 (FIG. 8) may scan to create raster image 880.

Although the present invention has been described in conjunction with certain embodiments, it is to be understood that modifications and variations may be resorted to without departing from the scope of the invention as those skilled in the art readily understand. Such modifications and variations are considered to be within the scope of the invention and the appended claims.

What is claimed is:

1. An apparatus comprising:
a laser light source;
an amplifier to drive the laser light source; and
a dithering circuit to drive the amplifier with a digital drive value in response to a digital word having more bits than the digital drive value, the dithering circuit including an accumulator to accumulate at least one least significant bit of the digital word.

2. The apparatus of claim 1 wherein the dithering circuit includes an adder circuit to modify at least one least significant bit of the digital drive value in response to overflow of the accumulator.

3. The apparatus of claim 1 wherein the amplifier comprises:
a digital-to-analog converter;
at least two comparators to compare an output of the digital-to-analog converter to ramp signals; and
at least two transistors coupled to drive the laser light source in response to the two comparators.

4. An apparatus comprising:
a laser light source;
a digital-to-analog converter to convert a digital drive value to an analog drive value;
a plurality of transistors coupled to drive the laser light source in parallel; and
a plurality of comparators coupled to compare the analog drive value to at least one ramp signal and to drive the plurality of transistors in response thereto.

5. The apparatus of claim 4 wherein the laser light source comprises a laser diode.

6. The apparatus of claim 4 further comprising a programmable power supply coupled to provide power to the plurality of transistors.

7. The apparatus of claim 6 further comprising a calibration circuit to adjust a power supply voltage provided by the programmable power supply.

8. The apparatus of claim 7 wherein the programmable power supply comprises a switching power supply.

9. The apparatus of claim 7 wherein the calibration circuit includes a photodetector to detect light output from the laser light source.

10. The apparatus of claim 4 wherein the plurality of transistors includes two transistors and the plurality of comparators comprises two comparators.

11. The apparatus of claim 10 further comprising a timing generator circuit to alternately select the two comparators to drive the two transistors.

12. The apparatus of claim 11 further comprising two ramp generator circuits to provide ramp signals to the two comparators.

13. The apparatus of claim 4 further comprising a dithering circuit to provide the digital drive value in response to a digital word having more bits than the digital drive value.

14. The apparatus of claim 13 wherein the dithering circuit comprises an accumulator to accumulate least significant bit values of the digital word, and to modify the digital drive value in response thereto.

15. A mobile device comprising:
a communications transceiver; and
a projection apparatus that includes a MEMS mirror to scan laser light on two axes, and at least one laser light source to produce the laser light, the laser light source having a laser drive apparatus that includes a plurality of drive transistors driven by comparators that are alternately enabled to drive the plurality of drive transistors.

16. The mobile device of claim 15 wherein the laser drive apparatus further comprises:
a digital-to-analog converter coupled to drive the comparators; and
at least one ramp generator coupled to drive the comparators.

17. The mobile device of claim 16 further comprising a dithering circuit to receive a first digital word having a first number of bits representing a commanded drive value, the dithering circuit to provide a second digital word having fewer bits than the first digital word to the digital-to-analog converter.

18. A method comprising:
converting a digital laser drive value to an analog laser drive signal;
alternately enabling a plurality of comparators that are responsive to the analog laser drive signal and ramp signals; and
driving a laser light source in response to the plurality of comparators.

19. The method of claim 18 further comprising dithering a digital commanded drive value to produce the digital laser drive value.

20. The method of claim 18 further comprising:
scanning a mirror that reflects the laser light to generate a raster image.
